(19) United States
(12) Patent Application Publication
(10) Pub. No.: US 2016/0375447 A1
(43) Pub. Date: Dec. 29, 2016

(54) ELECTRIC DUST COLLECTOR OF CYCLONE SEPARATOR

(71) Applicant: HIRATA CORPORATION, Kumamoto (JP)

(72) Inventors: Yuichiro HIRATA, Tokyo (JP); Toshihiro TOYOSHIMA, Tokyo (JP); Yoko OSUMI, Tokyo (JP); Maasa IZUMIDA, Tokyo (JP)

(73) Assignee: HIRATA CORPORATION, Kumamoto (JP)

(21) Appl. No.: 15/190,991

(22) Filed: Jun. 23, 2016

Related U.S. Application Data
(60) Provisional application No. 62/183,945, filed on Jun. 24, 2015.

(51) Int. Cl. B04C 9/00; B03C 3/36; B03C 3/68; B03C 3/74; B03C 3/15; B03C 3/41

(52) U.S. Cl. CPC B04C 9/00; B03C 3/15; B03C 3/41; B03C 3/68; B03C 3/74; B03C 3/363; B04C 2009/001

(57) ABSTRACT

A cyclone separator includes a centrifugal separator which separates solid matters from a fluid mixture containing fluid and solid matters. The centrifugal separator includes a fluid introducing unit which introduces the fluid subjected to the separation of the solid matters. An electric dust collector of the cyclone separator includes a main unit and a container. The container is provided in the fluid introducing unit and houses the main unit. The main unit includes an electrostatic member, an introducing member, a voltage applying unit and a controller. The introducing member is slidable along a longitudinal direction of the electrostatic member. The electrostatic member is switched to an electrically-charged state or a non-electrically-charged state by on and off control of the voltage applying unit using the controller. Minute particles of the solid matters are adhered to the electrostatic member by an electrostatic force generated by electrical charging of the electrostatic member.

### CROSS-REFERENCE TO RELATED APPLICATION

This application claims priority from U.S. Provisional Patent Application No. 62/183,945 filed on Jun. 24, 2014, the entire contents of which are incorporated herein by reference.

### FIELD OF THE INVENTION

The present invention relates to a cyclone separator, and more particularly, to a dust separation mechanism of a cyclone vacuum cleaner. As the dust separation mechanism, an electric dust collector is employed.

### BACKGROUND

A cyclone vacuum cleaner is known as one of cyclone separators. The vacuum cleaner suctions dust (solid matter) along with fluid such as water or air by rotating a motor. For example, a fluid mixture of the suctioned air and dust (dusty air: dust-containing air) is centrifuged, and clean air obtained by removing dust is discharged. For example, in the cyclone vacuum cleaner, first, the fluid mixture is introduced to a cyclone separator (centrifugal separator). The cyclone separator removes dust from the fluid mixture through centrifugation. Dust-removed air (clean air) is suctioned to a motor side and is discharged to the outside of the cleaner. Meanwhile, the removed dust is deposited in a dust collector provided in a bottom or the like of the cyclone separator, and is then discarded by a user of the cleaner in a suitable manner.

The cyclone vacuum cleaner is characterized in that no paper bag is necessary unlike a paper bag type vacuum cleaner. However, the cyclone separator of the cyclone vacuum cleaner is typically designed to exhibit desired performance when the motor is rotated at a predetermined number of revolutions (number of steady revolutions) or higher. Therefore, when the number of revolutions of the motor is lower than the number of steady revolutions immediately after a start of the motor and immediately before a stop of the motor, it is difficult to exhibit desired performance of the centrifugal separator. That is, in this case, dust removal using the centrifugal separator becomes imperfect. When the air is suctioned in which dust is imperfectly removed, that is, when the dust-containing air is suctioned to the motor, the motor may be clogged, and this may cause a failure and the like.

For this reason, the cyclone vacuum cleaner has a backup dust separation mechanism in order to perfectly remove dust even when the number of revolutions of the motor is lower than the number of steady revolutions. For example, a dust removal filter (hereinafter, referred to as a “filter”) may be provided between a downstream side of the centrifugal separator and an upstream side of the motor. In addition, an electric dust collector (hereinafter, referred to as an electrostatic force type) for removing dust may be provided between the downstream side of the centrifugal separator and the upstream side of the motor.

### SUMMARY

According to the present invention, an electrostatic force type dust collector, that is, an electric dust collector is employed as the dust separation mechanism. The electric dust collector is disposed in an internal space at the center of the centrifugal separator.

A cyclone separator includes a centrifugal separator which separates solid matters from a fluid mixture containing fluid and solid matters. The centrifugal separator includes a fluid introducing unit which introduces the fluid subjected to the separation of the solid matters. An electric dust collector of the cyclone separator includes a main unit and a container. The container is provided in the fluid introducing unit and houses the main unit. The main unit includes an electrostatic member, an introducing member, a voltage applying unit and a controller. The electrostatic member has a rod shape. The introducing member is provided in a flange shape along a circumferential surface of the electrostatic member. The introducing member is slidable along a longitudinal direction of the electrostatic member. The voltage applying unit applies a voltage to the introducing member. The controller controls the voltage applying unit. The electrostatic member is switched to an electrically-charged state or a non-electrically-charged state by on and off control of the voltage applying unit using the controller. Minute particles of the solid matters contained in the fluid subjected to the separation are adhered to the electrostatic member by virtue of an electrostatic force generated by electrical charging of the electrostatic member.

By applying the electric dust collector described above to the cyclone vacuum cleaner, it is possible to obtain advantages of the electrostatic force type, such as excellent maintainability, and prevent an increase of the size of the vacuum cleaner. In addition, since the electric dust collector is housed in the internal space at the center of the centrifugal separator, it is possible to eliminate a constraint such as interference between components. Therefore, it is possible to improve the degree of freedom in device layout and design management of the vacuum cleaner.

### BRIEF DESCRIPTION OF THE DRAWINGS

FIG. 1 is a top plan view illustrating an electric dust collector according to a preferred embodiment of the invention, for example, which is applied to is cyclone vacuum cleaner;

FIG. 2 is a partially cross-sectional view taken along the line II-II in FIG. 1;

FIG. 3 is an enlarged view illustrating main parts in FIG. 2;

FIG. 4 is a partially perspective view illustrating an electric dust collector according to a preferred embodiment of the invention;

FIG. 5 is a partially cross-sectional view illustrating an electric dust collector according to a preferred embodiment of the invention;

FIG. 6 is a schematic diagram illustrating a dust collecting state of the electric dust collector according to a preferred embodiment of the invention immediately after a start of the motor of the cyclone vacuum cleaner;

FIG. 7 is a schematic diagram illustrating a dust collecting state of the electric dust collector according to a preferred embodiment of the invention immediate before a stop of the motor of the cyclone vacuum cleaner;

FIG. 8 is a schematic diagram illustrating a dust removal structure of the electric dust collector according to a preferred embodiment of the invention after a stop of the motor of the cyclone vacuum cleaner;

FIG. 9 is a diagram illustrating an exemplary arrangement of electrodes in the electrostatic member illustrated in FIG. 5;

FIG. 10 illustrates a modification of FIG. 9; and

FIG. 11 illustrates another modification of FIG. 9.

### DETAILED DESCRIPTION

Since a filter type cyclone vacuum cleaner physically filters dust-containing air, it is possible to nearly perfectly remove the dust. However, it is necessary to periodically clean the filter or perform water washing, or exchange the filter in the event of a failure or aging. Furthermore, when the filter is washed with water, use of the vacuum cleaner is prohibited until the filter is dried.

Meanwhile, since an electrostatic force type cyclone vacuum cleaner collects or removes dust just by setting the applied voltage to ON/OFF, the periodic cleaning or water washing is not necessary unlike the filter type. That is, the electrostatic force type cyclone vacuum cleaner has excellent maintainability. However, since it is necessary to provide an electric dust collector separately from the centrifugal separator, the size of the device inevitably increases. Furthermore, in order to arrange both the centrifugal separator and the electric dust collector inside the vacuum cleaner, it is necessary to arrange them not to interfere with each other. Therefore, there is a constraint in the device layout.

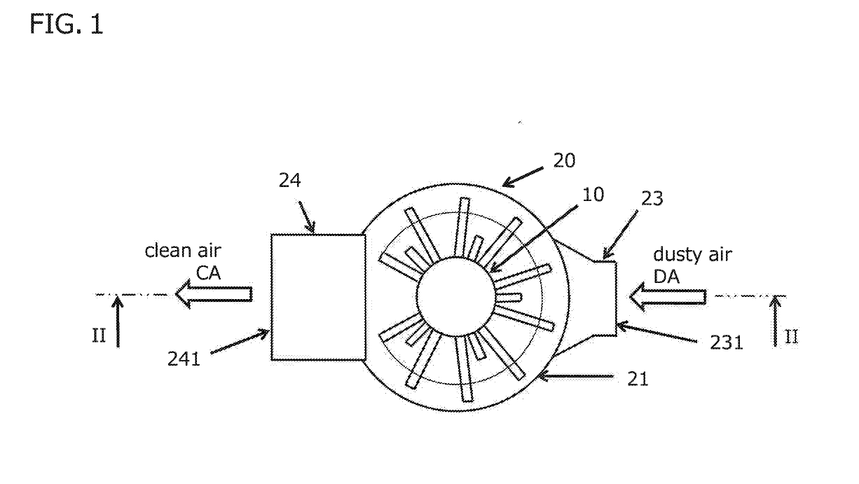

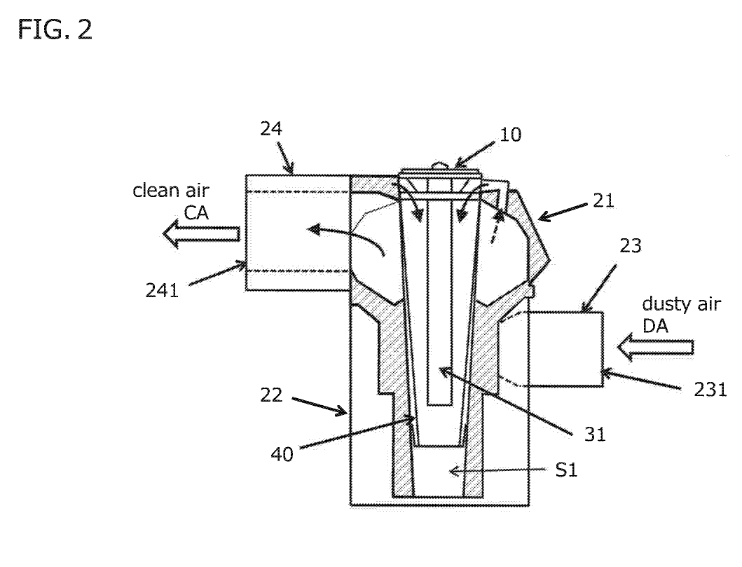

As illustrated in FIGS. 1 and 2, an electric dust collector 10 according to a preferred embodiment of the invention is employed, for example, in a cyclone vacuum cleaner 20. Specifically, the electric dust collector 10 is housed in an internal space S1 formed and opened on center-top of the centrifugal separator 21 of the cyclone vacuum cleaner 20.

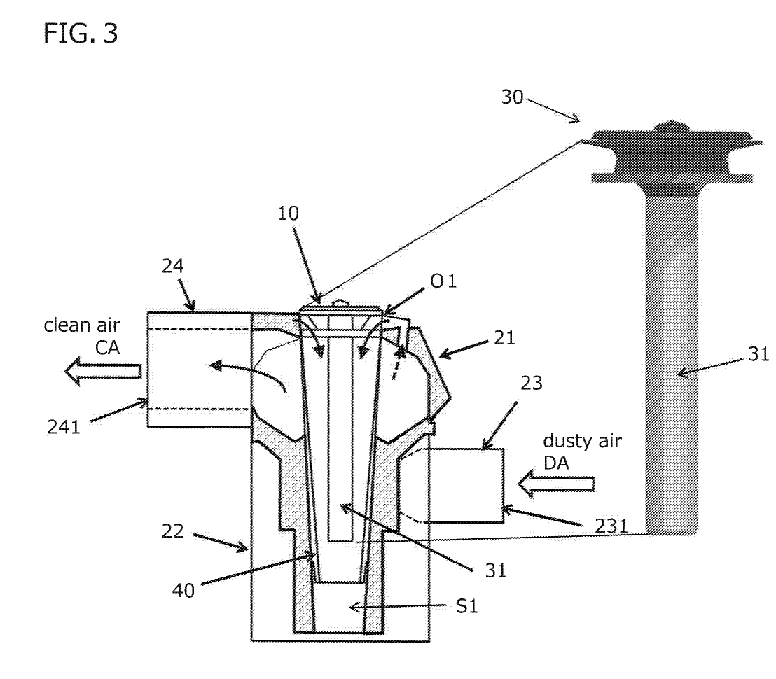

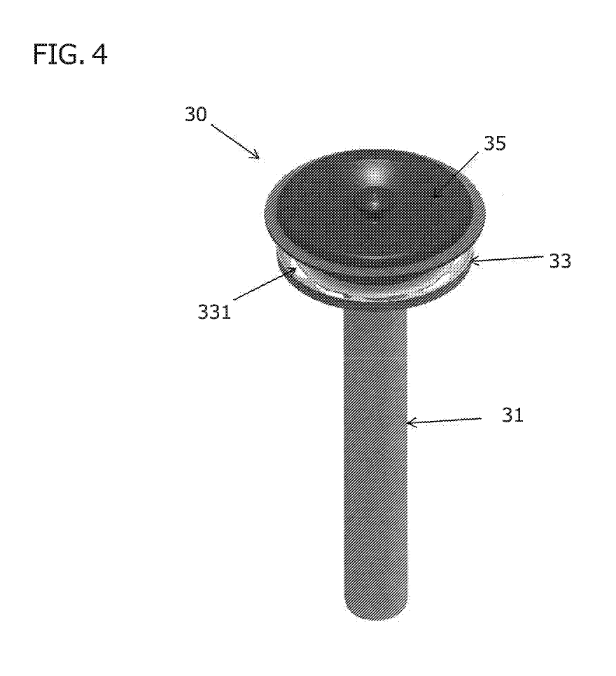

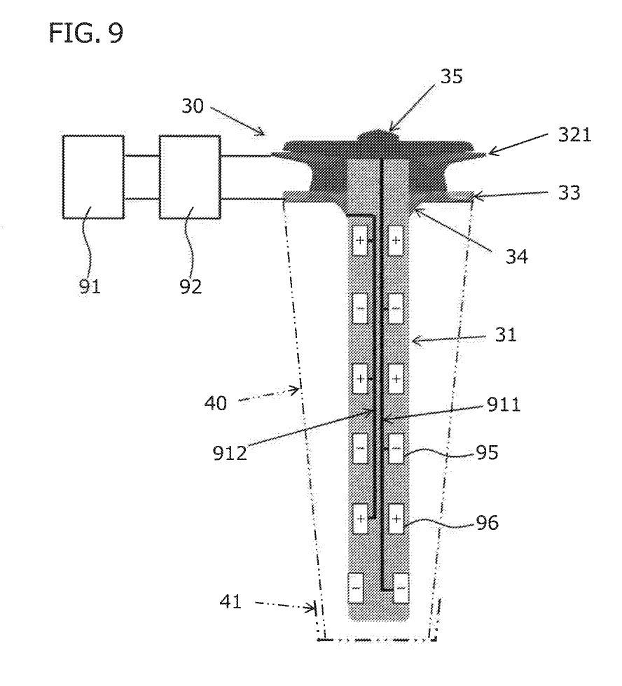

As illustrated in FIGS. 3 to 5, the electric dust collector 10 according to the preferred embodiment of the invention has a main unit 30 and a dust container 40. The main unit 30 has an electrostatic member 31 and a reel-like introducing member (reel member). The introducing member is provided in a flange shape on a circumferential surface of the electrostatic member 31 and is slidable along a longitudinal direction of the electrostatic member 31. The introducing member further has a straightening member 32, a metal collar 33, a scraper 34, and a grip member 35. The electrostatic member 31 can be electrically conducted using the scraper 34, the collar 33, and a voltage applying unit 91 (refer to FIG. 9) connected to the collar 33. As illustrated in FIG. 9, the voltage applying unit 91 can switch the electrostatic member 31 between an electrically-charged state and a non-electrically-charged state by ON/OFF control of the applied voltage using the controller 92. The dust container 40 is a cylindrical member tapered downward. A cap portion 41 is fitted to a bottom of the dust container. As the cap portion 41 is fitted to the cylindrical member, the cap portion 41 serves as a bottom of the dust container 40. Therefore, by removal of the cap portion 41 from the cylindrical member, the bottom of the dust container 40 comes out. The cap portion 41 is provided integrally with a shroud 22, which will be described below, serving as a dust receiver of the centrifugal separator 21.

The electrostatic member 31 is a rod member having a circular cross section, and may be formed of any material as long as it can be switched between an electrically-charged state and a non-electrically-charged state. For example, an insulator having weak conductivity such as ceramics may be employed. The electrostatic member 31 has an internal electrode, which will be described below. Preferably, the electrostatic member 31 is water-washable, and water can be easily dried or wiped out, so that a dust collecting capability can be regenerated through water washing. A reel-like introducing member provided with a ring-shaped straightening member 32 and a collar 33 (lower annular member) arranged in order from the upside is fitted to an upper end of the electrostatic member 31.

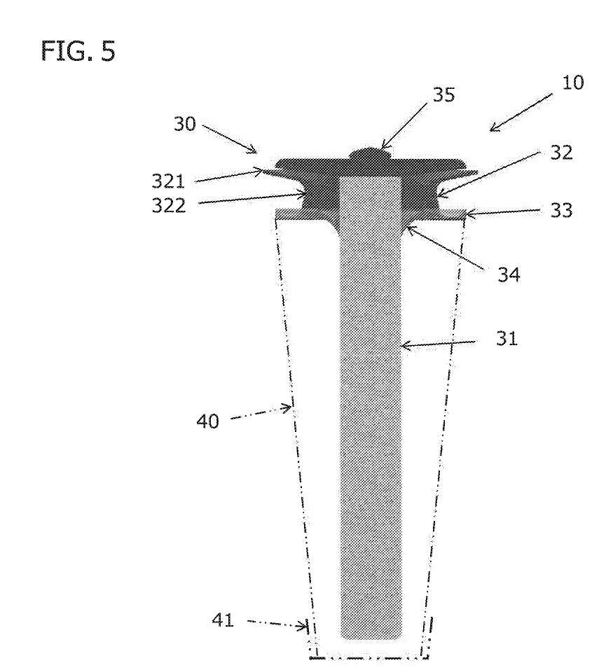

The straightening member 32 includes a ring-shaped upper plate portion 321 (upper annular member) and a hollow cylindrical member 323. In other words, a flange-shaped upper plate portion 321 is provided in the upper end of the cylindrical member 323. The upper plate portion 321 and the cylindrical member 323 may be provided either integrally or separately. A plurality of fin portions 322 formed in a radial shape to extend in an axial direction are provided on an outer circumferential surface of the cylindrical member 323. The collar 33 is provided with a plurality of slits 331 perforated in its outer peripheral edge along a circumferential direction. The scraper 34 is a ring-shaped member having an outer peripheral edge abutting on an inner circumference of the collar 33 and an inner peripheral edge abutting on an outer circumferential surface of the electrostatic member 31. The scraper 34 is formed of a material, such as conductive resin that is softer than the electrostatic member 31, electrically conductive, and has excellent tightness (sealing property) onto the electrostatic member 31. The grip member 35 is a lid member fixed to the electrostatic member 31. The straightening member 32 and the collar 33 are slidable with respect to the longitudinal direction of the electrostatic member 31 (in the vertical direction in FIG. 5). In other words, the grip member 35, the electrostatic member 31, the straightening member 32, and the collar 33 are movable relatively in the vertical direction.

Meanwhile, the dust container 40 is a container of the main unit 30 for housing the electrostatic member 31. The electric dust collector 10 is housed in an internal space S1 formed and opened on center-top of the centrifugal separator 21. When the electric dust collector 10 is housed, the straightening member 32 and the collar 33 of the electric dust collector 10 are seated on an opening O1 of the internal space S1 of the centrifugal separator 21 (refer to FIG. 3).

As illustrated in FIG. 9, the electrostatic member 31 is provided with two types of electrodes 95 and 96 provided in the vicinity of the surface layer of the outer circumferential surface in an alternating manner. Feed lines 911 and 912 of the voltage applying unit 91 are electrically connected to the electrode 95 and 96, respectively. In FIG. 9, six stages of the electrodes 95 and 96 are arranged side by side along the left and right circumferences in an alternating manner by way of example. However, each of the left and right electrodes shows a cross section of an integrated annular member. Here, each stage of the electrodes 95 and 96 is not limited to the integrated annular member. For example, a plurality of electrode pieces may he arranged along a circumferential direction at an equal interval, and each electrode piece may be connected to the feed line.

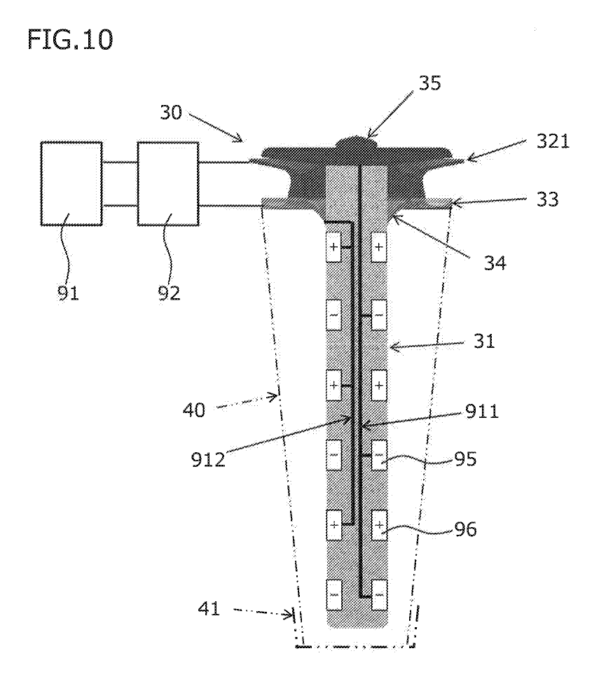

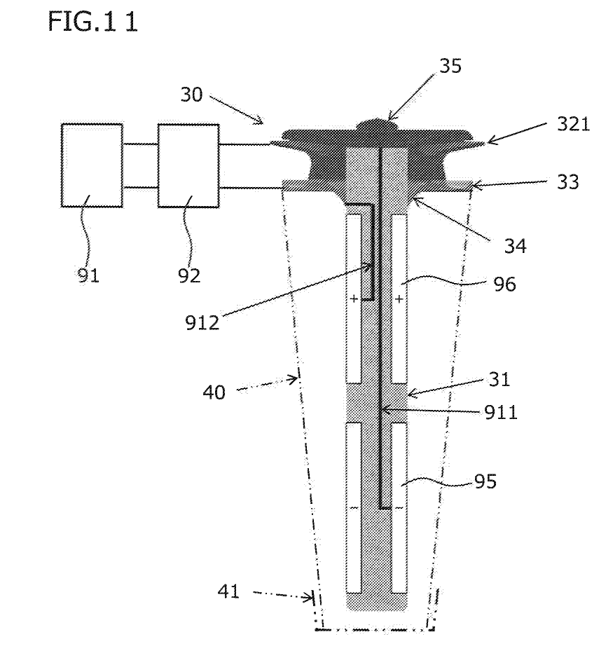

By virtue of electrostatic induction caused by the applied voltage, the surface layer of the electrostatic member 31 is charged with the same polarity as that of the electric charges charged in each electrode 95 and 96. As illustrated in FIG. 9, the electrodes 95 and 96 may be arranged in a non-exposed state in the vicinity of the surface layer of the outer circumferential surface of the electrostatic member 31. Alternatively, as illustrated in FIG. 10, the electrodes 95 and 96 may be exposed on the outer circumferential surface. Furthermore, a plurality of stages of the electrodes 95 and 96 may be provided as illustrated in FIGS. 9 and 10 (three stages in each of the left and right sides in the drawings), or a single stage may also be provided as illustrated in FIG. 11. Moreover, an interval between each stage of the electrodes 95 and 96 may be set without any particular limitation as long as a short circuit is not generated.

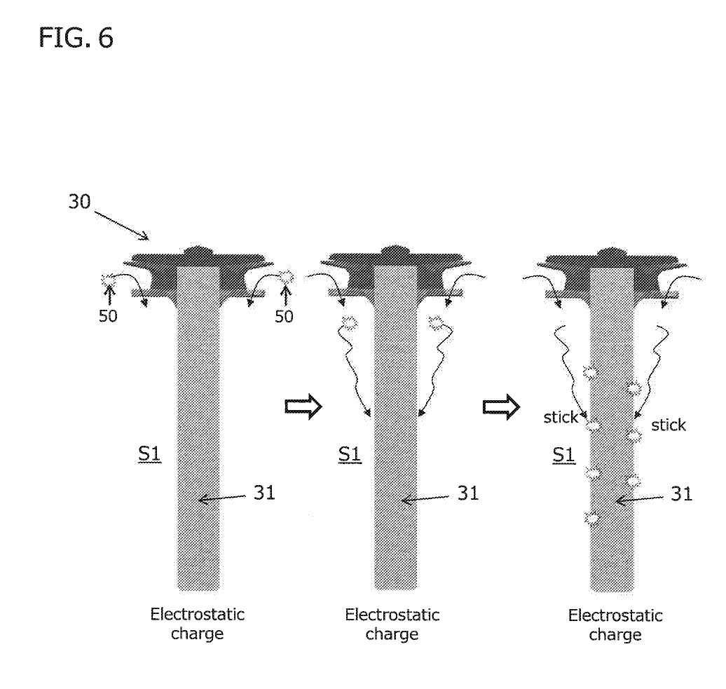

Next, functional effects obtained by applying the electric dust collector 10 according to this embodiment to the cyclone vacuum cleaner 20 will be described with reference to FIGS. 6 to 8. Note that the vacuum cleaner is omitted from FIGS. 6 to 8 in order to clarify a motion or flow of dust.

At the start of cleaning, first, a main power supply of the cyclone vacuum cleaner 20 is turned on, so that a safety lock of the control unit is released, and a voltage supply to the electrostatic member 31 is turned on by the voltage applying unit 91 as illustrated in FIG. 6. As a result, electric feeding is started through the straightening member 32, the collar 33, and the scraper 34, and the electrostatic member 31 is electrically charged. Then, a start button (not illustrated) of the vacuum cleaner 20 of FIGS. 1 and 2 is pressed, and a switch of the motor 24 is in ON, so that the dust-containing air (dusty air) DA is suctioned from a suction nozzle 231 of a suction module 23. The dust contained in the dusty air DA is removed by the centrifugal separator 21. However, immediately after the start of the motor 24, the number of revolutions of the motor 24 does not reach the number of steady revolutions even for a short period of time. For this reason, although most of the dust is removed by the centrifugal separator 21, very small particles of the dust 50 (minute solid matters) are not perfectly removed. In addition, the air containing very small particles of the dust 50 is introduced into the internal space S1. In this case, since the electrostatic member 31 has been electrically charged, the dust 50 introduced into the internal space S1 is adhered to the electrostatic member 31 sequentially by virtue of the electrostatic force. For this reason, even immediately after the start of the motor 24, overall dust including very small particles of dust 50 is perfectly removed by the centrifugal separator 21 and the electric dust collector 10. As a result, only the clean air CA is suctioned to the motor 24 and is discharged from an outlet port 241. In addition, the dusty air DA containing dust 50 guided to the electric dust collector 10 is straightened by the straightening member 32 into a downward flow and is guided to the collar 33. Furthermore, the downwardly straightened air DA is introduced to a space inside the dust container 40 from the slits 331 provided in the outer peripheral edge. That is, the air DA is introduced into the space inside the dust container 40 directly without making contact with the electrostatic member 31. Therefore, the dust 50 adhered to the electrostatic member 31 is not possibly removed due to this flow of the air DA.

The fluid subjected to the separation is introduced from a gap between the upper plate portion 321 and the collar 33 and is guided downward through a plurality of slits 331, so that the dust 50 contained in the fluid is adhered to the outer circumferential surface of the electrostatic member 31 electrically charged by the voltage supply set to ON. For example, human hair, animal hair, natural fiber, glass, and the like are adhered to the negative electrode 95, and chemical fiber and the like are adhered to the positive electrode 96.

Then, as the motor 24 reaches the number of steady revolutions, it is possible to perfectly separate the dust 50 solely using the centrifugal separator 21. For this reason, after the motor 24 reaches the number of steady revolutions, the dust 50 is not introduced into the internal space S1. In other words, after the motor 24 reaches the number of steady revolutions, only the clean air CA is introduced into the internal space S1. Here, preferably, the voltage supply to the electrostatic member 31 is maintained in ON continuously even after the motor 24 reaches the number of steady revolutions. The dust removed by the centrifugal separator 21 (excluding the dust 50 adhered to the electrostatic member 51) is collected inside the shroud 22 illustrated in FIGS. 1 and 2.

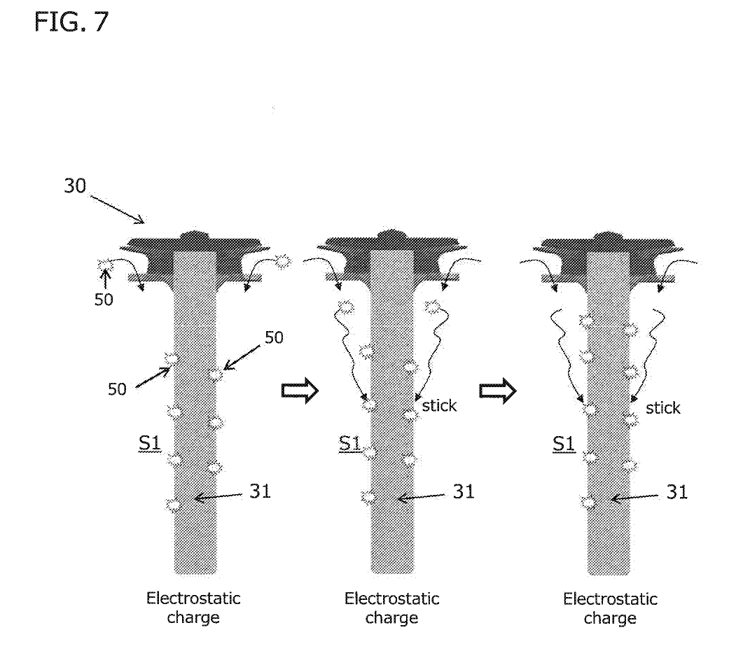

As the cleaning is completed, and the switch of the motor 24 of the vacuum cleaner 20 of FIGS. 1 and 2 is set to OFF, the rotation of the motor 24 stops. However, even when the switch is in OFF, the rotation of the motor 24 does not stop instantaneously, and the motor 24 continuously rotates by virtue of a force of inertia. For this reason, immediately before the motor 24 perfectly stops, the number of revolutions of the motor 24 does not reach the number of steady revolutions even for a very short period of time. For this reason, similar to the case generated immediately after the motor start, it is difficult to perfectly remove dust 50 using the centrifugal separator 21. In this regard, the electric dust collector 10 according to this embodiment is maintained in ON by continuously applying a voltage to the electrostatic member 31 for several seconds even after the switch of the motor 24 is set to OFF. As a result, as illustrated in FIG. 7, similar to the case generated immediately after the motor starts, the dust 50 is adhered to the electrostatic member 31 sequentially by virtue of the electrostatic force even immediately before the motor 24 perfectly stops.

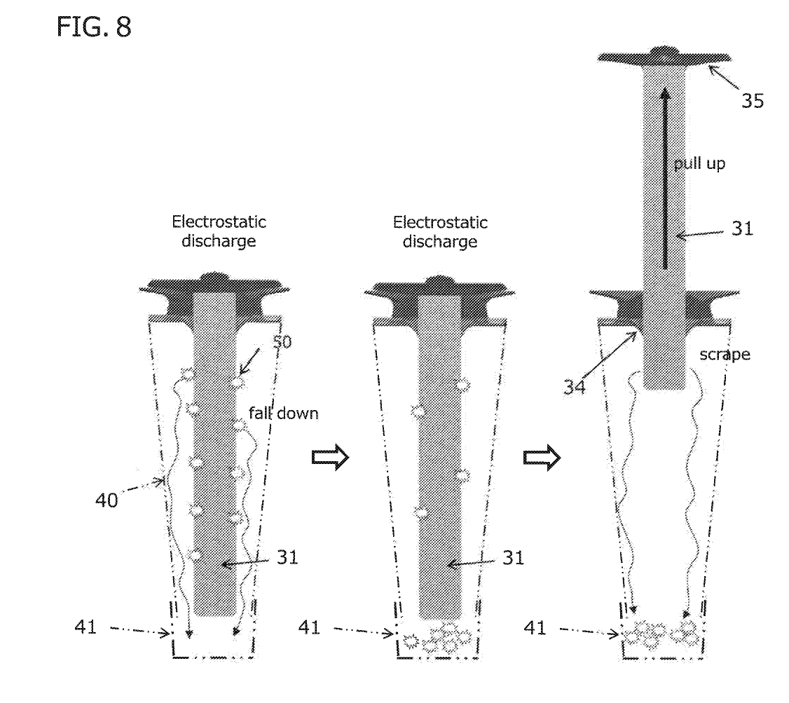

For a little while after the rotation of the motor 24 perfectly stops, the voltage supply to the electrostatic member 31 is perfectly set to OFF (to the non-electrically-charged state). Here, most of the dust 50 adhered to the electrostatic member 31 falls down from the electrostatic member 31 as illustrated in FIG. 8 as the electrostatic member 31 becomes in the non-electrically-charged state. The fallen dust 50 is collected in the dust container 40. However, a part of the dust 50 is still adhered to the electrostatic member 31 even when the electrostatic member 31 has the non-electrically-charged state.

Then, as an operator of the cleaner holds the grip member 35 and pulls up the electrostatic member 31, the electrostatic member 31 is lifted from the internal space S1. In this case, the spacer 34 abutting on the outer circumference of the electrostatic member 31 scrapes out the dust adhered to the electrostatic member 31, and almost of the dust 50 falls down to the dust container 40. Here, in the vacuum cleaner 20, the shroud 22 and the cap portion 41 of the dust container 40 are formed integrally. Therefore, by removing the shroud 22 of the vacuum. cleaner 20, the cap portion 41 is also removed along with the shroud 22. In this manner, by removing the cap portion 41, the dust container 40 becomes unbottomed, so that the dust accumulated in the dust container 40 falls down to the shroud 22. Then, the dust 50 is discarded along with the dust of the shroud 22 by an operator of the cleaner in a suitable manner.

In the electric dust collector 10 according to this embodiment, the cyclone vacuum cleaner 20 can perfectly remove very small particles of dust 50 without using a filter such as a paper bag even when the number of revolutions of the motor 24 is lower than the number of steady revolutions, for example, immediately after a start of the motor 24 and immediately before a perfect stop of the motor 24. Since the dust 50 is perfectly removed by the electric dust collector 10, the air suctioned to the motor 24 is the clean air CA at all times. For this reason, there is no need to worry about clogging or a failure of the motor 24.

In the electric dust collector 10 according to this embodiment, since the dust 50 is removed by virtue of the electrostatic force, it is not necessary to perform maintenance such as exchanging or cleaning of the filter unlike the cyclone vacuum cleaner of the related art. As a result, unlike the cyclone vacuum cleaner of the related art, it is possible to use the vacuum cleaner even during cleaning or drying of the filter. That is, by employing the electric dust collector 10 according to this embodiment in the cyclone vacuum cleaner, it is possible to prevent an increase of the size of the vacuum cleaner 20 while advantages of the electrostatic force type, such as excellent maintainability, can be obtained.

In addition, by housing the electric dust collector 10 in the internal space S1 provided in the center of the centrifugal separator 21, it is possible to eliminate a constraint such as interference between components. Therefore, it is possible to obtain a sufficient dust removal capability and improve the degree of freedom in device layout and design management of the vacuum cleaner 20.

According to this embodiment, the timing of electrically charging the electrostatic member 31 is set to the timing at which the main power of the cyclone vacuum cleaner 20 is turned on. However, the invention is not limited thereto. For example, the timing at which the start button (not illustrated) of the vacuum cleaner 20 is pressed may be set as the timing of electrically charging the electrostatic member 31. Here, the “timing at which the main power is turned on” refers to the timing at which the switch and the like are physically manipulated, the vacuum cleaner is removed from a charging station, or a power plug of the vacuum cleaner is inserted into an electrical outlet.

If the electrostatic member 31 is electrically charged when the start button (not illustrated) of the vacuum cleaner 20 is pressed, a slight time lag exists until the dust-containing air (dusty air) DA suctioned from the suction nozzle 231 reaches the electric dust collector 10 in practice even by setting the switch of the motor 24 to ON. During this time lag, it is possible to fully electrically charge the electrostatic member 31 using the voltage applying unit 91 and the controller 92.

The electric dust collector 10 according to this embodiment is suitably employed in the cyclone vacuum cleaner 20. In addition, the electric dust collector 10 according to this embodiment also be employed in any cyclone separator capable of separating a mixture into gas and solid matters or liquid and solid matters on the basis of a cyclone principle and an electrostatic force.

What is claimed is:

1. An electric dust collector of a cyclone separator, the cyclone separator having a centrifugal separator which separates solid matters from a fluid mixture containing fluid and solid matters, and the centrifugal separator having a fluid introducing unit which introduces the fluid subjected to the separation of the solid matters,
the electric dust collector comprising:
a main unit; and
a container that is provided in the fluid introducing unit and that houses the main unit,
wherein the main unit includes:
an electrostatic member that has a rod shape;
an introducing member that is provided in a flange shape along a circumferential surface of the electrostatic member and that is slidable along a longitudinal direction of the electrostatic member;
a voltage applying unit that applies a voltage to the introducing member; and
a controller that controls the voltage applying unit,
wherein the electrostatic member is switched to an electrically-charged state or a non-electrically-charged state by on and off control of the voltage applying unit using the controller, and
minute particles of the solid matters contained in the fluid subjected to the separation are adhered to the electrostatic member by virtue of an electrostatic force generated by electrical charging of the electrostatic member.

2. The electric dust collector according to claim 1,
wherein the introducing member is a reel member including a conductive upper annular member, a conductive lower annular member and a hollow cylindrical member which is provided in a middle portion of the reel member a vertical direction,
the electrostatic member is formed of an insulation material having weak conductivity and includes first and second electrodes at least in the vicinity of a surface layer of an outer circumferential surface of the electrostatic member,
the voltage applying unit and the upper annular member are electrically connected to each other such that a positive or negative voltage is applied to the first electrode, and
the voltage applying unit and the lower annular member are electrically connected to each other such that a negative or positive voltage is applied to the second electrode.

3. The electric dust collector according to claim 1,
wherein the introducing member is a reel member including a conductive upper annular member, a conductive lower annular member and a hollow cylindrical member which is provided in a middle portion of the reel member in a vertical direction,
the electrostatic member is formed of an insulation material having weak conductivity and includes first and second electrodes surfacing on an outer circumferential surface of the electrostatic member,
the voltage applying unit and the upper annular member are electrically connected to each other such that a positive or negative voltage is applied to the first electrode, and
the voltage applying unit and the lower annular member are electrically connected to each other such that a negative or positive voltage is applied to the second electrode.

4. The electric dust collector according to claim 2,
wherein the cylindrical member includes a plurality of fin portions provided in a radial shape on an outer circumferential surface of the cylindrical member, and
the lower annular member includes a plurality of slits provided discontinuously in a peripheral edge of the lower annular member along a circumferential direction.

5. The electric dust collector according to claim 4,
wherein the container includes:
a cylindrical housing member that houses the electrostatic member; and
a cap member that is fitted to a lower portion of the housing member, and
the electrostatic member is inserted into a hollow portion of the housing member, the lower annular member is seated on an upper opening of the housing member to block the upper opening, and the cap member is fitted to a lower opening of the housing member to block the lower opening.

6. The electric dust collector according to claim 5,
wherein the introducing member includes a ring-shaped scraper provided between the electrostatic member and the lower annular member, and
an outer edge of the scraper is connected to an inner circumference of the lower annular member and an inner edge of the scraper abuts on the outer circumferential surface of the electrostatic member.

7. The electric dust collector according to claim 4,
wherein the upper and lower annular members are formed of a conductive material.

8. The electric dust collector according to claim 6,
wherein the scraper is formed of a conductive material.

9. The electric dust collector according to claim 3,
wherein the cylindrical member includes a plurality of fin portions provided in a radial shape on an outer circumferential surface of the cylindrical member, and
the lower annular member includes a plurality of slits provided discontinuously in a peripheral edge of the lower annular member along a circumferential direction.

10. The electric dust collector according to claim 9,
wherein the container includes:
a cylindrical housing member that houses the electrostatic member; and
a cap member that is fitted to a lower portion of the housing member, and
the electrostatic member is inserted into a hollow portion of the housing member, the lower annular member is seated on an upper opening of the housing member to block the upper opening, and the cap member is filled to a lower opening of the housing member to block the lower opening.

11. The electric dust collector according to claim 10,
wherein the introducing member includes a ring-shaped scraper provided between the electrostatic member and the lower annular member, and
an outer edge of the scraper is connected to an inner circumference of the lower annular member and an inner edge of the scraper abuts on the outer circumferential surface of the electrostatic member.

12. The electric dust collector according to claim 9,
wherein the upper and lower annular members are formed of a conductive material.

13. The electric dust collector according to claim 11,
wherein the scraper is formed of a conductive material.
